(19) United States
(12) Patent Application Publication
(10) Pub. No.: US 2020/0132136 A1
(43) Pub. Date: Apr. 30, 2020

(54) CENTRIFUGAL CLUTCH FOR A DRIVE TRAIN OF A MOTOR VEHICLE, COMPRISING AT LEAST ONE FIXING ELEMENT FOR A COUNTERPRESSURE PLATE

(71) Applicant: Schaeffler Technologies AG & Co. KG, Herzogenaurach (DE)

(72) Inventors: Sebastian Heuberger, Bühl (DE); Martin Chambrion, Erstein (FR)

(73) Assignee: Schaeffler Technologies AG & Co. KG, Herzogenaurach (DE)

(21) Appl. No.: 16/467,290

(22) PCT Filed: Feb. 15, 2018
(86) PCT No.: PCT/DE2018/100135

§ 371 Date: Jun. 6, 2019

(30) Foreign Application Priority Data
Feb. 16, 2017 (DE) 10 2017 103 190.1

(51) Int. Cl. F16D 43/12

(52) U.S. Cl. CPC F16D 43/12; F16D 13/52

(57) ABSTRACT

A centrifugal clutch for a drive train of a motor vehicle includes an input part, an output part, a friction unit, a counterpressure plate, a shifting device, and a snap ring. The output part is arranged coaxially and rotatably in relation to the input part and includes a leaf-spring core with a fixing element. The friction unit includes first friction elements connected to the input part and second friction elements connected to the leaf-spring core. The second friction units are arranged in alternate layers with the first friction elements in an axial direction. The shifting device is arranged to clamp the first friction elements and the second frictional elements against the counterpressure plate for frictional engagement in response to a centrifugal force. The fixing element extends through the counterpressure plate. The counterpressure plate is fixed to the fixing element by the snap ring.

### CROSS-REFERENCE TO RELATED APPLICATIONS

This application is the United States National Phase of PCT Appln. No. PCT/DE2018100135 filed Feb. 15, 2018, which claims priority to German Application No. DE102017103190.1 filed Feb. 16, 2017, the entire disclosures of which are incorporated by reference herein.

### TECHNICAL FIELD

The present disclosure relates to a centrifugal clutch for a drive train of a motor vehicle. Centrifugal clutches are used in drive trains of motor vehicles, e.g. motorcycles, lightweight motorcycles or scooters, to equalize an input speed and a transmission speed, especially during starting processes of the motor vehicle.

### BACKGROUND

Layered friction elements connected torsionally to an input part and an output part of the centrifugal clutch are clamped under the action of the centrifugal force, for example, with the result that, given a sufficient centrifugal force, frictional engagement is established between the input part and the output part and a torque is transmitted. Normally, clamping of the friction elements is accomplished by radially outward movement of centrifugal elements, e.g. centrifugal weights, arranged between a ramp device in accordance with the centrifugal force, with the result that an axially movable disk part preloads the friction elements directly or indirectly counter to the action of a spring, so that, with increasing radially outward movement of the centrifugal bodies, the frictional engagement increases as the speed of the input part increases, e.g. during a starting process, and torque is transferred successively from the input part to the output part.

Centrifugal clutches of this kind can be combined with an automated transmission, e.g. a continuously variable transmission (CVT). WO 2015/135540 A1, for example, discloses a centrifugal clutch which has a shifting device shifting in accordance with the centrifugal force in the centrifugal clutch, which acts as a starting element, and, in addition, a clutch release device that can be actuated by the driver as a selector clutch, which disengages the engaged centrifugal clutch counter to the centrifugal force and engages said clutch. In this case, the centrifugal clutch engaged by the shifting device that shifts in accordance with the centrifugal force engages only at relatively high speeds of the drive under the action of the centrifugal force in order to enable a required starting torque to be provided. As the speeds fall, however, the centrifugal clutch disengages at relatively high speeds as a result, and therefore no torque from the drive is available at low speeds above the idling speed of the drive if the motor vehicle is still being driven.

There are therefore also known centrifugal clutches, the output part of which has a second shifting device that shifts in accordance with the centrifugal force. This makes possible both starting of the motor vehicle at a high speed of the drive and also driving at low speeds, e.g. in a part-load mode, since decoupling of the centrifugal clutch as a result of the centrifugal force takes place only at relatively low speeds. For this purpose, as is known, the input part has a first (drive-side) shifting device that shifts in accordance with the centrifugal force and, in addition, the output part has a second (transmission-side) shifting device that shifts in accordance with the centrifugal force. Both shifting devices that shift in accordance with the centrifugal force act on the friction elements with an axial force to bring about frictional engagement. This means that, as the speed of the input part rises and the speed of the output part rises, i.e. when the motor vehicle is being driven, the centrifugal clutch is engaged in accordance with the centrifugal force, i.e. in accordance with the speed of the drive and of the transmission, until, when an idling speed of the drive is reached and the motor vehicle is substantially stationary, for example, the friction clutch is disengaged again. When the motor vehicle is stationary, the centrifugal clutch can therefore be engaged only at relatively high speeds and therefore at a power sufficient for a speedy starting process. Owing to the additional action on the friction elements by means of the second (transmission-side) shifting device while the motor vehicle is being driven, the centrifugal clutch remains engaged up to speeds below the coupling speed during the starting process or continues to transmit torque, at least in a slipping mode. However, the disadvantage with such centrifugal clutches is the large amount of effort involved in their assembly.

The disclosure describes a centrifugal clutch for a drive train of a motor vehicle including an input part and an output part arranged coaxially and rotatably in relation to the input part and having a friction unit that can be shifted in accordance with the centrifugal force. The friction unit includes first friction elements connected to the input part for conjoint rotation therewith and second friction elements connected to a leaf-spring core of the output part for conjoint rotation therewith. The first and second friction elements are arranged in alternate layers in an axial direction and, to engage the centrifugal clutch, can be brought into frictional engagement and clamped against a counterpressure plate by means of at least one shifting device that shifts in accordance with the centrifugal force. The leaf-spring core has at least one fixing element, which extends through the counterpressure plate and to which the counterpressure plate is fixed by means of a snap ring.

The proposed centrifugal clutch is provided for a drive train of a motor vehicle, e.g. a motorcycle, lightweight motorcycle, scooter, lightweight scooter, passenger car or the like. Motor vehicles of this kind generally have a drive, e.g. an internal combustion engine, and a transmission. The transmission can be in the form of a continuously variable transmission (CVT), automatic transmission or shift transmission shifted manually by a driver, for example.

The centrifugal clutch includes a drive-side input part, which is arranged so as to be rotatable about an axis of rotation by means of the drive and which can be connected directly or indirectly to a crankshaft of the drive, for example. Furthermore, the centrifugal clutch includes an output part, which is arranged coaxially and rotatably in relation to the input part and which can be connected indirectly or directly to a transmission input shaft of the transmission, for example. A friction unit that can be shifted in accordance with the centrifugal force and act in the circumferential direction is provided between the input part and the output part. The friction unit includes first friction elements connected to the input part for conjoint rotation therewith and second friction elements connected to a leaf-spring core of the output part for conjoint rotation therewith.

The first and second friction elements can be arranged in alternate layers in an axial direction and, to engage the centrifugal clutch, can be brought into frictional engagement by means of at least one shifting device that shifts in accordance with the centrifugal force. In particular, the first friction elements and/or the second friction elements are manufactured in the form of rings and/or at least partially from steel. Moreover, the first friction elements and/or the second friction elements can have friction linings. The first friction elements and second friction elements can be clamped in the axial direction between a counterpressure plate and, for example, a pressure plate of the leaf-spring ring or a contact pressure ring of an inner disk carrier.

In order to enable the motor vehicle to be started at a high speed of the drive and nevertheless to enable decoupling in accordance with the centrifugal force only at low speeds when the motor vehicle is being driven, so as to drive in a part-load mode, for example, a first (drive-side) shifting device that shifts in accordance with the centrifugal force can be provided between the input part and the first friction elements (in a power flow direction of the torque), and a second (transmission-side) shifting device that shifts in accordance with the centrifugal force can be provided between the output part and the second friction elements (in the power flow direction of the torque). Both shifting devices that shift in accordance with the centrifugal force act on the first friction elements and second friction elements of the friction unit in an axial direction with a contact pressure force to bring about frictional engagement. This means that, as the speed of the input part rises and/or the speed of the output part rises, i.e. when the motor vehicle is being driven, the centrifugal clutch is engaged or remains engaged in accordance with the centrifugal force, i.e. in accordance with the speeds of the drive and of the transmission, until, when an idling speed of the drive is reached and the motor vehicle is substantially stationary, for example, the centrifugal clutch is disengaged again. When the motor vehicle is stationary, the centrifugal clutch can therefore be engaged only at relatively high speeds and therefore at a propulsion power sufficient for a speedy starting process.

Owing to the additional action on the friction unit, while the motor vehicle is being driven, by means of the second (transmission-side) shifting device that shifts in accordance with the centrifugal force, the friction clutch remains engaged up to speeds below the coupling speed during the starting process or continues to transmit torque, at least in a slipping mode. Moreover, the at least one shifting device that shifts in accordance with the centrifugal force can be connected to the pressure plate of the leaf-spring core by means of at least one preloaded spring, thus enabling the centrifugal clutch to be disengaged by the driver independently of the shift state of the centrifugal clutch, which is determined by the centrifugal force, by moving the pressure plate that clamps the first friction elements and second friction elements away from the counterpressure plate, counter to the action of the spring.

Moreover, a minimum (axial) spacing between the pressure plate and the counterpressure plate can be set in such a way that there is no preload acting between the first friction elements and second friction elements when there is no centrifugal force, and the centrifugal clutch is therefore disengaged, irrespective of any drag torques that may occur in the case of wet centrifugal clutches.

The leaf-spring core has at least one fixing element, which extends through the counterpressure plate and to which the counterpressure plate is fixed by means of a snap ring. The snap ring is, in particular, a special form of a retaining ring used to fix the counterpressure plate in the axial direction on the at least one fixing element. In particular, the snap ring is of annular design and has a gap at one point. Furthermore, the snap ring can be composed at least partially of spring steel. This design enables the centrifugal clutch to be assembled from three (preassembled) modules: input part, output part and leaf-spring core, thus reducing the effort required for the assembly of the centrifugal clutch.

The at least one fixing element may be designed as at least one fixing arm. It is possible, for example, for the at least one fixing arm to be formed on an outer circumferential surface of a hub of the leaf-spring core and/or to extend in the axial direction.

Moreover, the at least one fixing element may be designed as at least one bolt. It is likewise possible for the at least one bolt to be fixed to the hub of the leaf-spring core and/or to extend in the axial direction. It is possible here, in particular, for the bolt to extend through leadthrough openings in the pressure plate of the leaf-spring core.

The at least one fixing element may have at least one groove for the snap ring. It is possible, in particular, for the snap ring to be inserted into the at least one groove, thus ensuring that the counterpressure plate is fixed to the leaf-spring core in the axial direction.

The leaf-spring core may have a hub, which can be connected to a transmission input shaft of a transmission of the motor vehicle, and a pressure plate for the friction unit. The pressure plate is fixed to the hub for conjoint rotation therewith by means of at least one leaf spring and can be adjusted to a limited extent in the axial direction relative to the hub. In particular, the hub has splines, by means of which the hub can be connected positively to a transmission input shaft of the transmission. The pressure plate may be fixed to the hub by a plurality of leaf springs, which are stacked one on top of the other and/or distributed in a circumferential direction of the hub. The at least one leaf spring is fixed to the hub and the pressure plate by means of rivets, for example, ensuring that the hub and the pressure plate are fixed in terms of rotation relative to one another but the pressure plate can be adjusted to a limited extent in the axial direction relative to the hub.

The first friction elements and second friction elements can be clamped between the pressure plate and the counterpressure plate by means of the at least one shifting device that shifts in accordance with the centrifugal force. For this purpose, the pressure plate can be adjusted, particularly in the axial direction, by the at least one shifting device that can be shifted in accordance with the centrifugal force, thus ensuring that an axial clearance between the pressure plate and the counterpressure plate is reduced.

The pressure plate may have at least one actuating arm for a clutch release bearing, which arm extends through the hub in the axial direction. In particular, the at least one actuating arm is formed on an inner circumferential surface of the pressure plate. In particular, the clutch release bearing allows the centrifugal clutch to be disengaged by a driver independently of the shift state of the centrifugal clutch, which is determined by the centrifugal force.

The second friction elements may be fixed to the leaf-spring core for conjoint rotation therewith by means of an inner disk carrier. In particular, the inner disk carrier is of cup-shaped configuration and/or the second friction elements are fixed to an outer circumferential surface of the inner disk carrier in a manner which prevents relative rotation and/or allows movement in the axial direction. In particular, the inner disk carrier is furthermore fixed to the pressure plate of the leaf-spring core for conjoint rotation therewith.

The at least one leaf spring may be subject to tension in an engaged state of the centrifugal clutch, with the result that a contact pressure force on the friction unit is increased. The at least one leaf spring is arranged at an angle to the hub and the pressure plate, with the result that, when the centrifugal clutch is engaged, a tension force is introduced into the at least one leaf spring, pulling the pressure plate in the direction of the counterpressure plate in the axial direction, thus increasing the contact pressure force on the friction unit. It is thereby advantageously possible to transmit a higher torque. It is not necessary here for all the second friction elements to be used to intensify the contact pressure force; as an option, only the second friction elements which are connected to the pressure plate for conjoint rotation therewith are used. This makes the centrifugal clutch less sensitive to torque fluctuations, and an overrun torque introduced into the at least one leaf spring is lower, thereby ensuring that the at least one leaf spring cannot buckle. This also enables the at least one leaf spring to be made simpler and thinner, for example, since it is then only subject to very little compressive stress. It is thereby possible to reduce the weight of the centrifugal clutch.

The at least one leaf spring may be subject to compressive stress in an engaged state of the centrifugal clutch, with the result that a contact pressure force on the friction unit is increased. In this embodiment, the at least one leaf spring is likewise arranged at an angle to the hub and the pressure plate of the leaf-spring core, with the result that, in the engaged state of the centrifugal clutch, a compressive force is introduced into the at least one leaf spring, pressing the pressure plate of the leaf-spring core in the direction of the counterpressure plate in the axial direction. This likewise increases the contact pressure force on the friction unit.

### BRIEF DESCRIPTION OF THE DRAWINGS

The disclosure and the technical environment are explained in greater detail below by means of the figures. It should be noted that the figures show variants of the disclosure but that the disclosure is not restricted thereto. In the figures, identical parts are provided with the same reference signs. By way of example and schematically:

FIG. 1 shows a first variant of a centrifugal clutch in an exploded illustration;

FIG. 2 shows a perspective illustration of a leaf-spring core of the first variant of the centrifugal clutch;

FIG. 3 shows a section through the leaf-spring core of the first variant of the centrifugal clutch;

FIG. 4 shows a perspective illustration of a hub of the leaf-spring core of the first variant of the centrifugal clutch;

FIG. 5 shows a perspective illustration of a pressure plate of the leaf-spring core of the first variant of the centrifugal clutch;

FIG. 6 shows a section through the first variant of the centrifugal clutch;

FIG. 7 shows a second variant of a centrifugal clutch in an exploded illustration;

FIG. 8 shows a perspective illustration of the leaf-spring core of the second variant of the centrifugal clutch;

FIG. 9 shows a section through the leaf-spring core of the second variant of the centrifugal clutch;

FIG. 10 shows a section through the inner disk carrier of the second variant of the centrifugal clutch; and

FIG. 11 shows a section through the second variant of the centrifugal clutch.

### DETAILED DESCRIPTION

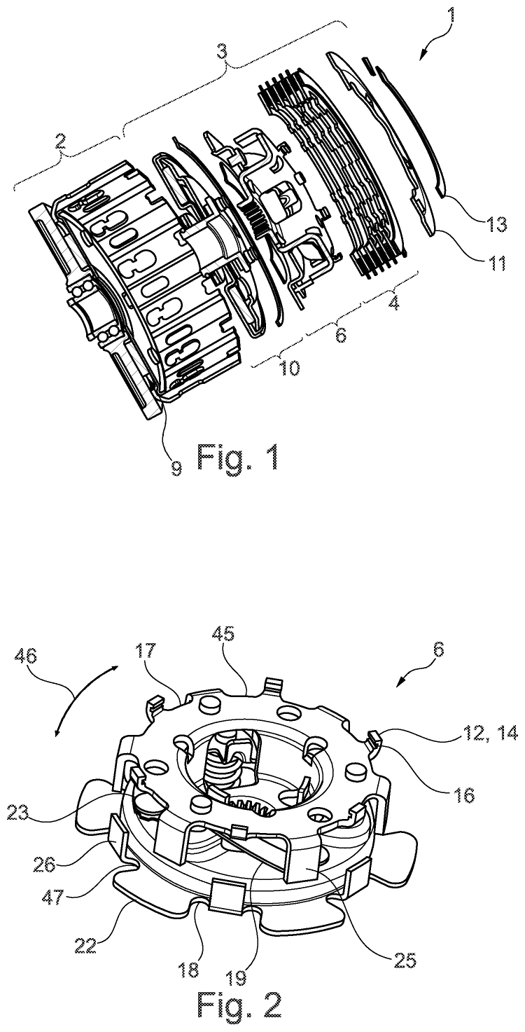

FIG. 1 shows an exploded illustration of a first variant of a centrifugal clutch 1 in section. The centrifugal clutch 1 has an input part 2 having a first shifting device 9, which shifts in accordance with the centrifugal force, and an output part 3. The output part 3 includes a second shifting device 10, which shifts in accordance with the centrifugal force, a leaf-spring core 6, a friction unit 4, a counterpressure plate 11 and a snap ring 13. The friction unit 4 includes first friction elements 5, which are connected to the input part 2 for conjoint rotation therewith, and second friction elements 7, which are connected to the leaf-spring core 6 for conjoint rotation therewith.

FIG. 2 shows a perspective illustration of the leaf-spring core 6 of the first variant of the centrifugal clutch 1, which is shown in FIG. 1. The leaf-spring core 6 includes a hub 17 and a pressure plate 18. The pressure plate 18 is fixed to the hub 17 for conjoint rotation therewith by leaf springs 19. For this purpose, the leaf springs 19 are fixed to the hub 17 and the pressure plate 18 by means of rivets 23. On a first outer circumferential surface 45, the hub 17 has fixing elements 12, which are arranged in a manner distributed in a circumferential direction 46 and in this case are designed in the manner of fixing arms 14. Moreover, the fixing elements 12 each have a groove 16 for the snap ring 13 shown in FIG. 1. Also formed on the first outer circumferential surface 45 are first arms 25, which are used to receive some of the second friction elements 7 of the friction unit 4, which are shown in FIG. 1.

On a second outer circumferential surface 47, the pressure plate 18 furthermore includes second arms 26, which are likewise used to receive some of the second friction elements 7 shown in FIG. 1 in a manner fixed against relative rotation. Also formed on the second outer circumferential surface 47 of the pressure plate 18 are contact pressure lugs 22, which serve to press the first friction elements 5 and second friction elements 7 shown in FIG. 1 against the counterpressure plate 11.

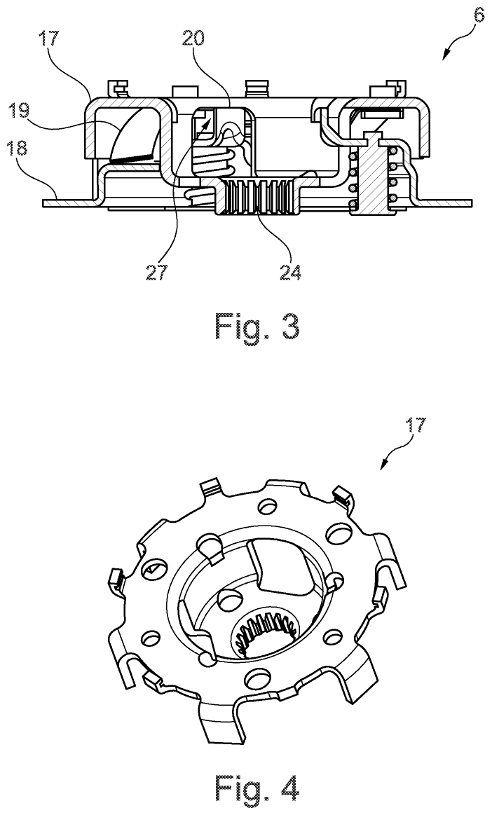

FIG. 3 shows the leaf-spring core 6, shown in FIG. 2, in section. Here, it can be seen, in particular, that the hub 17 has splines 24, by means of which the hub 17 can be connected positively and for conjoint rotation to a transmission input shaft (not shown here) of a transmission of a motor vehicle. The pressure plate 18 is fixed to the hub 17 by means of the leaf springs 19. The pressure plate 18 has actuating arms 20, which extend through openings 27 in the hub 17, for a clutch release bearing (not shown here).

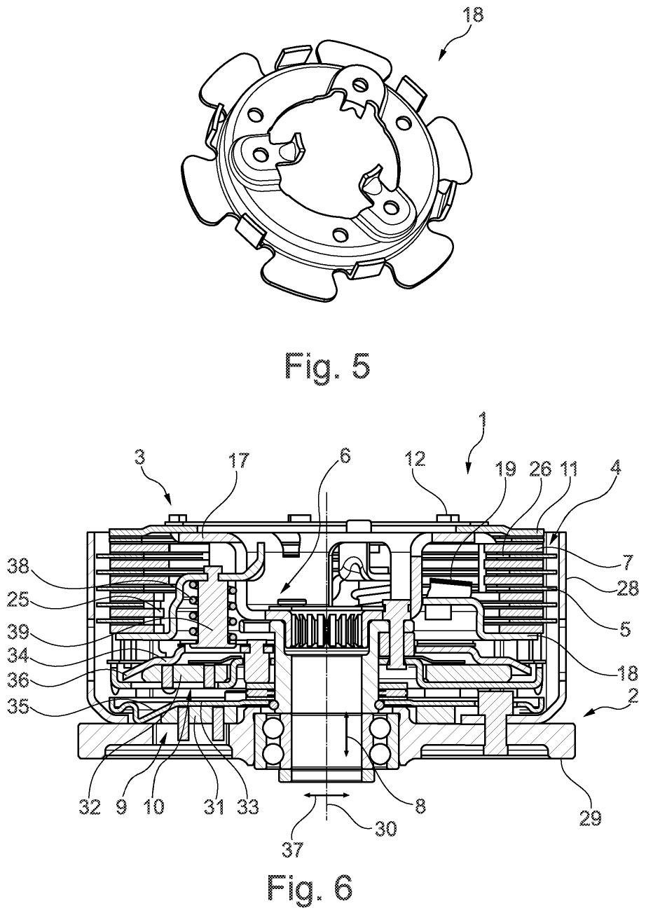

FIG. 4 shows the hub 17 and FIG. 5 shows the pressure plate 18 in a perspective illustration.

FIG. 6 shows the first variant of the centrifugal clutch 1 in a perspective illustration. The centrifugal clutch 1 has the input part 2 with an input plate 29, which can be rotated about an axis of rotation 30 by a drive (not shown here), and an outer disk carrier 28, which is fixed on the input plate 29 for conjoint rotation therewith. First friction elements 5 of a friction unit 4 are connected to the outer disk carrier 28 of the input part 2 for conjoint rotation therewith. Moreover, the friction unit 4 has second friction elements 7, which are fixed to the hub 17 and the pressure plate 18 of the leaf-spring core 6 for conjoint rotation therewith.

The input part 2 has the first shifting device 9, which rotates with the input part 2 and shifts in accordance with the centrifugal force. The first shifting device 9 includes first centrifugal weights 31, which are moved outward in a radial direction 37 as a centrifugal force of the rotating input part 2 increases, with the result that the centrifugal weights 31 move a first disk part 33 in an axial direction 8, i.e. parallel to the axis of rotation 30, by means of a first ramp 35 of the first disk part 33. The first disk part 33 is coupled mechanically to the pressure plate 18 of the leaf-spring core 6 in such a way that the pressure plate 18 is adjusted in the direction of the counterpressure plate 11, counter to a spring force of the leaf springs 19, in the axial direction 8. The first friction elements 5 and the second friction elements 7 are thereby clamped between the pressure plate 18 and the counterpressure plate 11 and, as a result, enter into frictional engagement, thus enabling a torque to be transferred from the input part 2 to the output part 3.

The output part 3 includes a second shifting device 10, which is connected to the hub 17 for conjoint rotation therewith, shifts in accordance with the centrifugal force and has second centrifugal weights 32. As the centrifugal force of the rotating output part 3 increases, the second centrifugal weights 32 are moved outward in the radial direction 37, with the result that a second disk part 34 is adjusted in the direction of the counterpressure plate 11 in the axial direction 8 by means of second ramps 36. The second disk part 34 is coupled mechanically to the pressure plate 18 by means of a plurality of preloaded springs 38, only one of which can be seen here, thus enabling the pressure plate 18 to be adjusted in the direction of the counterpressure plate 11 in the axial direction 8. The first friction elements 5 and the second friction elements 7 of the friction unit 4 are thereby likewise clamped and brought into frictional engagement, thus enabling the torque to be transferred from the input part 2 to the output part 3. The springs 38 are each arranged on guide pins 39.

The three lower second friction elements 7 are connected to the pressure plate 18 for conjoint rotation therewith by means of the first arms 25, and the three upper second friction elements 7 are connected to the hub 17 for conjoint rotation therewith by means of the second arms 26. Since the leaf springs 19 extend at an angle to the hub 17 and the pressure plate 18, a contact pressure force introduced into the friction unit 4 by the pressure plate 18 is intensified as the centrifugal clutch 1 is engaged, and a higher torque can be transferred from the input part 2 to the output part 3. In the first variant of the centrifugal clutch 1, however, not all of the second friction elements 7 of the friction unit 4 are used to intensify the contact pressure force but only the three lower second friction elements 7, which are passed through the pressure plate 18. This makes the centrifugal clutch 1 less sensitive to torque fluctuations, and an overrun torque introduced into the leaf springs 19 is lower, thereby ensuring that the leaf springs 19, which are subject to compressive stress, cannot buckle.

The fixing elements 12 of the hub 17 extend through the counterpressure plate 11, thus enabling the counterpressure plate 11 to be fixed to the hub 17 of the leaf-spring core 6 by means of the snap ring 13 shown in FIG. 1.

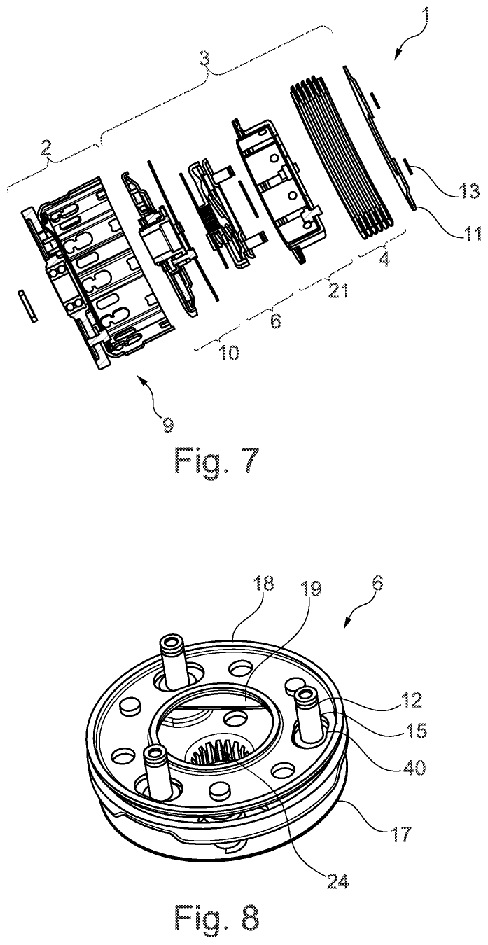

FIG. 7 shows an exploded illustration of a second variant of a centrifugal clutch 1 having an input part 2 and an output part 3. The input part 2 has a first shifting device 9, which shifts in accordance with the centrifugal force, and is of identical design to the input part 2 of the first variant of the centrifugal clutch 1. The output part 3 includes a second shifting device 10, which shifts in accordance with the centrifugal force, a leaf-spring core 6, an inner disk carrier 21, a friction unit 4, a counterpressure plate 11 and a snap ring 13.

FIG. 8 shows the leaf-spring core 6 in a perspective illustration. The leaf-spring core 6 includes a hub 17, to which a pressure plate 18 is rotatably fixed by means of leaf springs 19. The hub 17 has splines 24, by means of which the hub 17 can be fixed for conjoint rotation to a transmission input shaft (not shown here) of a transmission of a motor vehicle. Three fixing elements 12, which in this case are designed in the manner of bolts 15, are fixed to the hub 17. The fixing elements 12 extend through leadthrough openings 40 in the pressure plate 18.

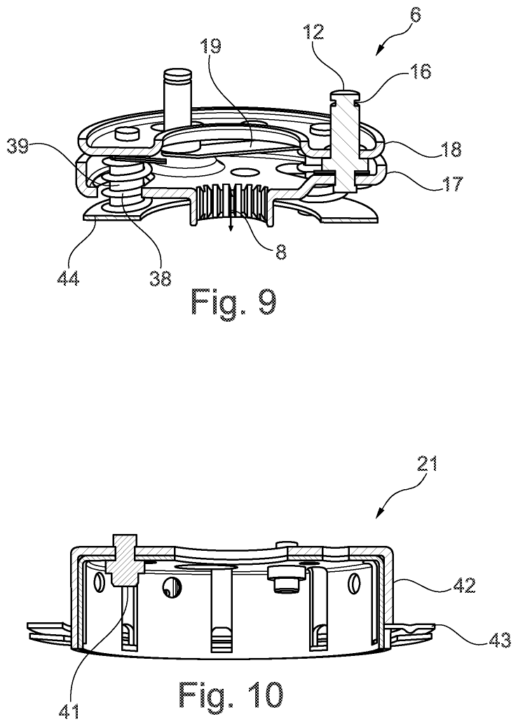

FIG. 9 shows a section through the leaf-spring core 6. The fixing elements 12 of the hub 17 each have a groove 16 for the snap ring 13 shown in FIG. 7. The leaf springs 19 enable the pressure plate 18 to be moved to a limited extent in an axial direction 8 relative to the hub 17. The pressure plate 18 is connected to a third disk part 44 by means of guide pins 39, wherein a preloaded spring 38 is arranged on each of the guide pins 39 between the pressure plate 18 and the third disk part 44.

FIG. 10 shows a section through an inner disk carrier 21. The inner disk carrier 21 is fixed for conjoint rotation to the pressure plate 18 (shown in FIGS. 8 and 9) of the leaf-spring core 6 by means of connecting elements 41. The inner disk carrier 21 has a third outer circumferential surface 42, to which the friction unit 4 shown in FIG. 7 can be fixed for conjoint rotation therewith. Moreover, the inner disk carrier 21 has, on the third outer circumferential surface 42, a contact pressure ring 43, by means of which the friction unit 4 can be pressed against the counterpressure plate 11 shown in FIG. 7.

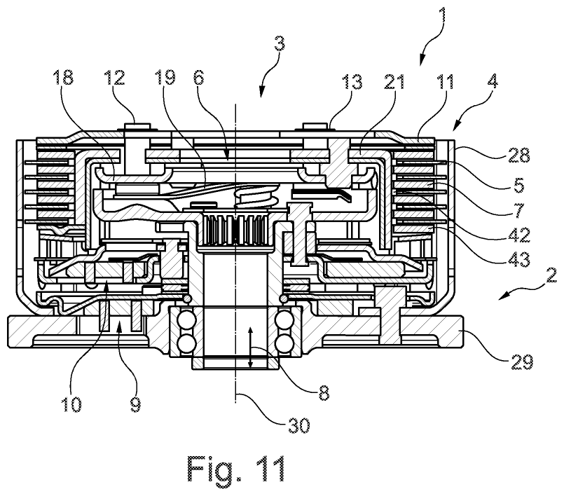

FIG. 11 shows the second variant of the centrifugal clutch 1 in section. Apart from the leaf-spring core 6 and the inner disk carrier 21, the second variant of the centrifugal clutch 1 is of substantially identical design to the first variant of the centrifugal clutch 1, which is shown in FIGS. 1 to 6, and therefore only the essential differences will be explored below and otherwise reference is made to the description of the first variant of the centrifugal clutch 1. The second variant of the centrifugal clutch 1 too has an input part 2 having an input plate 29 and an outer disk carrier 28, which can be rotated around an axis of rotation 30 by a drive (not shown here), and first friction elements 5 of a friction unit 4 are fixed to the outer disk carrier 28 for conjoint rotation therewith. Furthermore, the friction unit 4 includes second friction elements 7, which are arranged for conjoint rotation on the third outer circumferential surface 42 of the inner disk carrier 21, while the inner disk carrier 21 is connected to the pressure plate 18 of the leaf-spring core 6 for conjoint rotation therewith.

The input part 2 has the first shifting device 9, which shifts in accordance with the centrifugal force, and the output part 3 has the second shifting device 10, which shifts in accordance with the centrifugal force. By means of the first shifting device 9 and/or the second shifting device 10, the pressure plate 18 can be moved in the direction of the counterpressure plate 11 in an axial direction 8, i.e. parallel to the axis of rotation 30. The first friction elements 5 and the second friction elements 7 of the friction unit 4 are thereby clamped between the contact pressure ring 43 of the inner disk carrier 21 and the counterpressure plate 11 and brought into frictional engagement, thereby engaging the centrifugal clutch 1.

The engagement of the centrifugal clutch 1 enables a torque to be transferred from an input part 2 to the output part 3. During this process, the leaf springs 19 are subject to compressive stress, as a result of which the pressure plate 18 is pressed in the direction of the counterpressure plate 11 in the axial direction 8, with the result that a contact pressure force introduced into the friction unit 4 by the contact pressure ring 43 is intensified. The fixing elements 12 extend through the counterpressure plate 11 in the axial direction 8, thus enabling the counterpressure plate 11 to be fixed to the hub 17 of the leaf-spring core 6 by means of the snap ring 13.

The centrifugal clutches 1 are distinguished especially by a low effort on assembly.

### REFERENCE NUMERALS

1 centrifugal clutch
2 input part
3 output part
4 friction unit
5 first friction element
6 leaf-spring core
7 second friction element
8 axial direction
9 first shifting device
10 second shifting device
11 counterpressure plate
12 fixing element
13 snap ring
14 fixing arm
15 bolt
16 groove
17 hub
18 pressure plate
19 leaf spring
20 actuating arm
21 inner disk carrier
22 contact pressure lugs
23 rivet
24 splines
25 first arm
26 second arm
27 openings
28 outer disk carrier
29 input plate
30 axis of rotation
31 first centrifugal weight
32 second centrifugal weight
33 first disk part
34 second disk part
35 first ramp
36 second ramp
37 radial direction
38 spring
39 guide pin
40 leadthrough opening
41 connecting element
42 third outer circumferential surface
43 contact pressure ring
44 third disk part
45 first outer circumferential surface
46 circumferential direction
47 second outer circumferential surface

1.-10. (canceled)

11. A centrifugal clutch for a drive train of a motor vehicle comprising:
an input part;
an output part arranged coaxially and rotatably in relation to the input part and comprising a leaf-spring core with at least one fixing element;
a friction unit comprising:
first friction elements connected to the input part for conjoint rotation therewith; and,
second friction elements connected to the leaf-spring core for conjoint rotation therewith, and arranged in alternate layers with the first friction elements in an axial direction;
a counterpressure plate;
at least one shifting device; and,
a snap ring, wherein:
the at least one shifting device is arranged to clamp the first friction elements and the second frictional elements against the counterpressure plate for frictional engagement in response to a centrifugal force;
the at least one fixing element extends through the counterpressure plate; and,
the counterpressure plate is fixed to the at least one fixing element by the snap ring.

12. The centrifugal clutch of claim 11, wherein the at least one fixing element is a fixing arm.

13. The centrifugal clutch of claim 11, wherein the at least one fixing element is a bolt.

14. The centrifugal clutch of claim 11, wherein the at least one fixing element comprises a groove for the snap ring.

15. The centrifugal clutch of claim 11, wherein the second friction elements are fixed to the leaf-spring core for conjoint rotation therewith by an inner disk carrier.

16. The centrifugal clutch of claim 11, wherein the leaf-spring core comprises:
a hub arranged for connection to a transmission input shaft of a transmission of the motor vehicle; and,
a pressure plate for the friction unit, fixed to the hub for conjoint rotation therewith by at least one leaf spring, and adjustable relative to the hub in the axial direction.

17. The centrifugal clutch of claim 16, wherein the at least one shifting device is arranged to clamp the first friction elements and the second friction elements between the pressure plate and the counterpressure plate in response to the centrifugal force.

18. The centrifugal clutch of claim 16, wherein:
the pressure plate comprises an actuating arm for a clutch release bearing; and,
the actuating arm extends through the hub in the axial direction.

19. The centrifugal clutch of claim 16, wherein the at least one leaf spring is subject to tension in an engaged state of the centrifugal clutch to increase a contact pressure force on the friction unit.

20. The centrifugal clutch of claim 16, wherein the at least one leaf spring is subject to compressive stress in an engaged state of the centrifugal clutch to increase a contact pressure force on the friction unit.
